(19) United States
(12) Patent Application Publication
(10) Pub. No.: US 2009/0162503 A1
(43) Pub. Date: Jun. 25, 2009

(54) METHOD FOR APPLICATION OF A SHAPABLE MASS TO A FREELY SHAPABLE OBJECT

(75) Inventor: Guido Knobel, Warth (CH)

Correspondence Address: DYKEMA GOSSETT PLLC, 39577 WOODWARD AVENUE, SUITE 300, BLOOMFIELD HILLS, MI, 48304-5086, US

(73) Assignee: KMB PRODUKTIONS AG, Felben (CH)

(21) Appl. No.: 12/162,941

(22) PCT Filed: Jan. 31, 2007
(86) PCT No.: PCT/EP07/00797

§ 371 Date: Nov. 18, 2008

(30) Foreign Application Priority Data
Jan. 31, 2006 (DE) 102006004654.4

(51) Int. Cl. A23P 1/08; G05D 7/06; G06F 3/041; G06F 3/048; G06K 9/00

(52) U.S. Cl. 426/231; 700/283; 715/702; 715/764; 382/141

(57) ABSTRACT

The invention relates to a method for applying a shapable mass from an application head of a machine, corresponding to a desired design, onto a freely shapable object in the food and/or chemical industry according to the instructions of a controller. In an embodiment an image/photograph of the object is generated and transferred into a machine control system. The contours to be provided by the shapable mass are subsequently traced, and contour data is transmitted to the controller and used to control the application of the shapable mass from the application head onto an object.

The invention relates to a method for applying a shapable mass from an application head of a machine, corresponding to a desired design, onto a freely shapable object in the food and/or chemical industry according to the instructions of a control system, and an apparatus for same.

### PRIOR ART

In many sectors of the food and chemical industry it is necessary to coat a given object with a shapable mass. A shapable mass may be a cream of any type, a dough of any type, or chocolate, for example. As a rule the shapable mass is fluid, and is applied to specific regions of the object via an application head of a machine. For this purpose, of course, the regions must be specified. To this end, in current practice a drawing is created using a computer graphics program, generally in the machine operating or control system itself. This requires a software specialist who not only creates the drawing, but then also processes it.

By use of transfer software the created file is then entered into the machine control system (provided that the file is not created in the machine control system itself) or is transferred to a robot.

The unit is then moved to a neutral point, and the computer program is started.

### OBJECT OF THE INVENTION

The object of the present invention is to provide a method and an apparatus of the above-referenced type, by means of which the application of a shapable mass in a desired design onto a freely shapable object is significantly simplified and improved.

### Achievement of the Object

The object is achieved by the fact that an image/photograph of the object is generated and read into a machine control system, and the contours to be provided by the shapable mass are subsequently traced, and these data are transmitted to the controller for the application head.

The major advantage of the present invention is that any given user, using an appropriate device, is able to generate an image/photograph of the object to be shaped and enter same into the machine control system. On the display of the machine control system the user is able to precisely trace the contours, which are to be coated with the shapable mass, on the object actually displayed, This does not require a software specialist or additional graphics software.

The image of the object may be generated in any given manner. For example, the object may be scanned or traversed with appropriate probes in order to determine the surface contours. In one preferred exemplary embodiment, however, for simplicity and also for originality a photograph is taken by a digital camera, and this photograph is read into the machine control system via a USB data carrier. Of course, it would also be possible to take an analogous photograph, which is then read into the machine control system using a scanner. However, this is much more laborious than using a digital camera.

Current machine control systems generally also have a display. The image/photograph of the object to be shaped can be represented on this display. It is also possible to magnify or reduce the object to simplify tracing of the contours to be provided by the shapable mass.

After these contours have been traced, for example using a mouse, or directly on a touch screen (any given input device or input option, for example a finger or speech input, is intended to be encompassed by the invention), it is necessary only to set the height of the application head, and after starting the machine the object is shaped.

In the present apparatus according to the invention for applying a shapable mass from an application head of a machine, corresponding to a desired design, onto a freely shapable object in the food and/or chemical industry according to the instructions of a controller, the controller as part of a machine control system may be connected to a device for transmitting an image/photograph. Also associated with the machine control system is an input device or a corresponding input option for tracing a contour to be provided by the shapable mass.

### DESCRIPTION OF THE FIGURES

Further advantages, features, and particulars of the invention result from the following description of preferred exemplary embodiments and with reference to the drawings, which show the following:

FIG. 1 shows a schematically illustrated side view of a user of the method according to the invention who is taking a photograph of an object to be shaped;

FIG. 2 shows a perspective view of a machine control system with a digital camera attached;

FIG. 3 shows a perspective view of the machine control system according to FIG. 2, in a further method step;

FIG. 4 shows a partially illustrated enlarged perspective view of the machine control system according to FIG. 2, in a further method step;

FIG. 5 shows an enlarged section of a display for the machine control system;

FIG. 6 shows a partially illustrated perspective view of a machine for applying a shapable mass; and

FIG. 7 shows an enlarged section of the machine according to

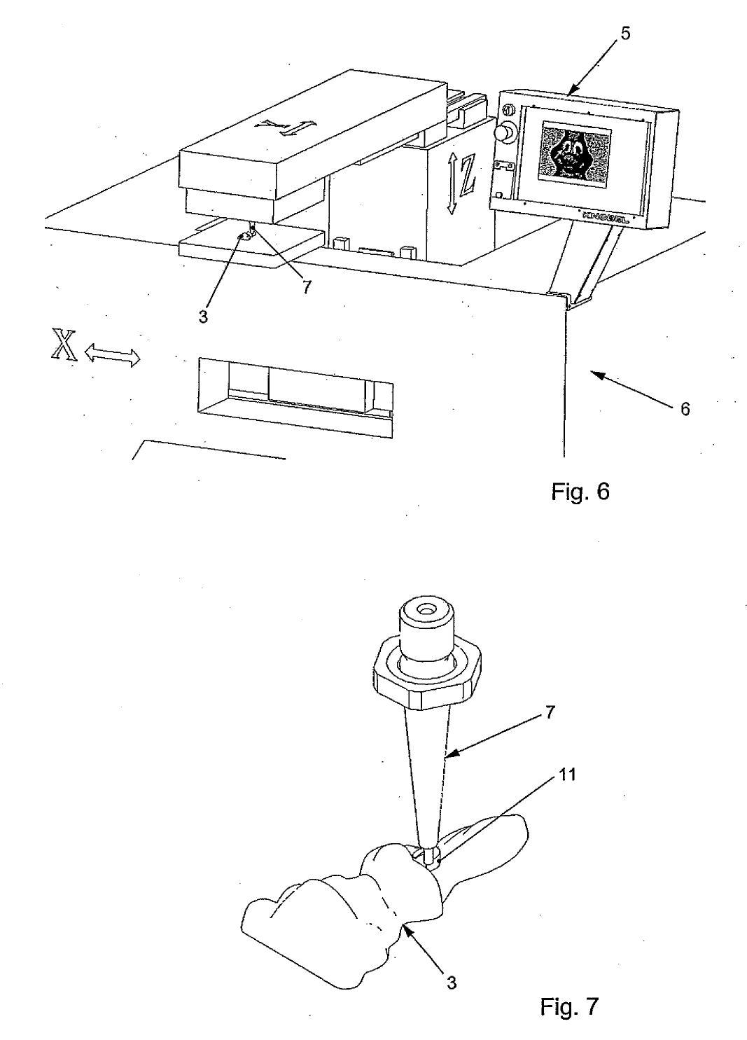

FIG. 6.

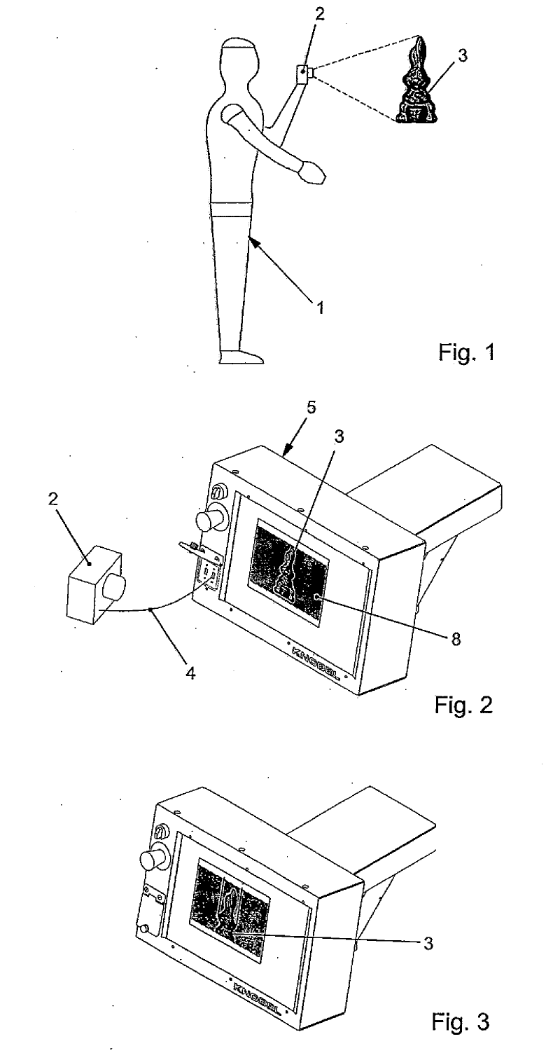

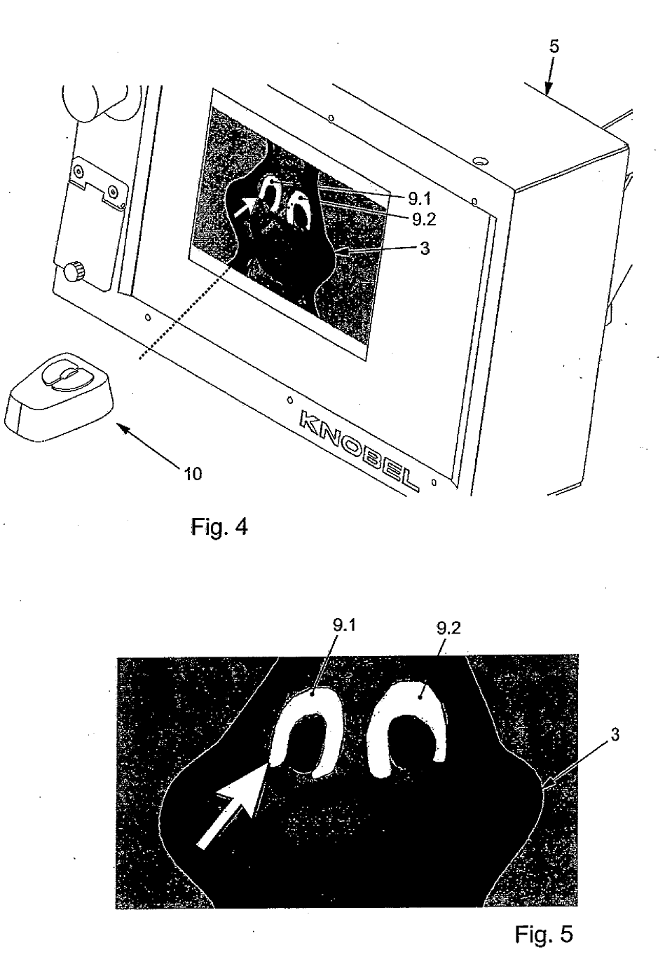

Corresponding to the method according to the invention, in a first method step according to FIG. 1 a user 1 records a shapable object, for example a chocolate rabbit 3, using a digital camera 2. According to FIG. 2, the digital camera 2 is then connected via a USB cable 4 to a machine control system 5 for a machine 6, partially illustrated in FIG. 6, for applying a shapable mass from an application head 7, corresponding to a desired design, onto the object 3. This machine control system has a display 8 on which the object 3 to be shaped may be represented.

In a further method step according to FIG. 3 the object 3 is scaled, i.e., modified in size. This is performed as desired by the user.

Regions 9.1 and 9.2 on the object 3 which are to be coated with a shapable mass are determined. In the present case, the shapable mass is used to define the eyes of the rabbit. According to the concept of the invention, the appropriate regions 9.1 and 9.2 are traced using a mouse 10 so that these regions are displayed on the screen, as shown in particular in FIG. 5.

According to FIGS. 6 and 7 the starting height of the application head 7 is then fixed, the application head 7 being a decorating nozzle. The shapable mass 11 is applied from this decorating nozzle 7 onto the object 3, precisely in the specified regions 9.1 and 9.2.

List of reference numerals

| | |
|---|---|
| 1 | User |
| 2 | Digital camera |
| 3 | Object |
| 4 | USB cable |
| 5 | Machine control system |
| 6 | Machine |
| 7 | Application head |
| 8 | Display |
| 9 | Regions |
| 10 | Mouse |
| 11 | Mass |
| 12 | |
| 13 | |
| 14 | |
| 15 | |
| 16 | |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |

1.-11. (canceled)

12. A method for applying a shapable mass from an application head of a machine onto an object in the food or chemical industry according to instructions provided by a controller, the method comprising:
obtaining an image/photograph of said object;
transferring the image/photograph into a machine control system;
providing a representation of the image/photograph on a display;
tracing contours of a shapable mass; and
transmitting data associated with the contours to said controller; and
controlling the application of said shapable mass from said application head onto said object.

13. The method according to claim 12, wherein the image/photograph is generated using a digital camera.

14. The method according to claim 12, wherein the image/photograph is transferred into the machine control system directly via the digital camera.

15. The method according to claim 12, wherein the image/photograph is transferred into the machine control system via a USB data carrier.

16. The method according to claim 12, wherein the image/photograph is scaled before tracing a contour.

17. The method according to claim 12, wherein a height of the application head relative to said object is set before said shapable mass is applied to said object.

18. The method according to claim 12, wherein said shapable mass comprises an edible food product.

19. The method according to claim 12, wherein said shapable mass is in fluid form during application to said object.

20. The method according to claim 12, wherein said object comprises a food product.

21. An apparatus for applying a shapable mass corresponding to a desired design onto an object in the food or chemical industry, the apparatus comprising:
a machine including an application head for applying said shapable mass onto said object;
a machine control system including a controller that provides instructions to the application head;
a transmitting device for transmitting an image/photograph; and
an input device for tracing a contour of a shapable mass;
wherein the transmitting device is connected to the controller, and the input device is connected to the machine control system.

22. The apparatus according to claim 21, wherein the transmitting device includes a scanner.

23. The apparatus according to claim 21, wherein the transmitting device includes a digital camera.

24. The apparatus according to claim 21, wherein the transmitting device is connected to the machine control system via a USB data carrier.

25. The apparatus according to claim 21, wherein the tracing is performed on a screen.

26. The apparatus according to claim 21, wherein the tracing is performed directly on a touch screen.

27. The apparatus according to claim 21, wherein the tracing is performed using a mouse, the mouse being operatively connected to the machine control system.

28. The apparatus according to claim 27, wherein the connection between the mouse and machine control system is wireless.

29. The apparatus according to claim 21, wherein the application head includes a decorating nozzle.

30. The apparatus according to claim 21, wherein said shapable mass comprises a food product.

31. An apparatus for applying an edible food coating corresponding to a desired design onto a food product, the apparatus comprising:
a machine including an application head for applying said edible food coating onto said food product;
a machine control system including a controller that provides application instructions to the application head;
a means for transmitting an image/photograph, the means for transmitting connected to the controller; and
a means for tracing a contour of desired edible food coating, the means for tracing connected to the machine control system.
